(19) United States
(12) Patent Application Publication
(10) Pub. No.: US 2023/0315556 A1
(43) Pub. Date: Oct. 5, 2023

(54) METHOD AND SYSTEM FOR DETERMINING LOG FEATURE SEQUENCE, METHOD AND SYSTEM FOR ANALYZING BUG, AND ELECTRONIC DEVICE

(71) Applicant: Beijing Unisoc Communications Technology Co., Ltd., Beijing (CN)

(72) Inventors: Hong YU, Beijing (CN); Hui ZHANG, Beijing (CN)

(21) Appl. No.: 18/042,201

(22) PCT Filed: Aug. 20, 2021
(86) PCT No.: PCT/CN2021/113788

§ 371 Date: Feb. 17, 2023

(30) Foreign Application Priority Data
Aug. 21, 2020 (CN) 202010850552.7

(51) Int. Cl. G06F 11/07; G06F 21/57

(52) U.S. Cl. CPC G06F 11/0766; G06F 21/577

(57) ABSTRACT

A method and system for determining log feature sequence, a method and system for analyzing bug, and an electronic device. The method for determining log feature sequence includes: extracting an original feature sequence of a log sample set including a plurality of log samples each includes a log related to a bug and a correct category of a cause of the bug; conducting, for feature sequences before and after deletion of at least one feature element from the original feature sequence, classification prediction through a classification algorithm; and determining a target feature sequence according to a maximum error ratio of each log sample before and after deletion of the feature element.

The present application is a National Phase of International Application No. PCT/CN2021/113788, filed on Aug. 20, 2021, which claims priority to Chinese Patent Application No. 202010850552.7, filed on Aug. 21, 2020, the contents of which are herein incorporated by reference in their entireties.

### TECHNICAL FIELD

The present disclosure relates to the field of computer technologies and, in particular, to a method for determining log feature sequence, a method and system for analyzing bug, and an electronic device.

### BACKGROUND

A bug is a vulnerability in a computer caused by flaws in a system security policy, which may allow an attacker to access or damage the system without authorization. Engineers usually analyze logs related to the bug to obtain causes of the bug. A feature sequence of the logs may be extracted, and then the causes of the bug in the logs are predicted through a classification algorithm.

The classification refers to classifying a text into an existing category based on the feature or attribute of the text. Commonly adopted classification algorithms include: decision tree algorithm, Bayes classification algorithm, support vector machine (SVM) classification algorithm, artificial neural network (ANN) classification algorithm, k-nearest neighbor (KNN) classification algorithm, fuzzy classification algorithm, etc.

In the related art, there are various algorithms for extracting the feature sequence of logs. However, each feature extraction algorithm inevitably suffers from the problem of inaccurate extraction results, thus leading to an inaccurate result of classification prediction on causes of the bug in the logs through the classification algorithm.

### SUMMARY

The technical problem to be solved by the present disclosure is to provide a method and system for determining log feature sequence, a method and system for analyzing bug, and an electronic device, to overcome the defect in the related art that a feature sequence extracted from logs is inaccurate, thus leading to an inaccurate result of classification prediction of causes of a bug by a classification algorithm.

The present disclosure solves the foregoing technical problems through the following technical solutions:

According to a first aspect, the present disclosure provides a method for determining log feature sequence, including: extracting an original feature sequence of a log sample set, the log sample set includes a plurality of log samples, and each of the log samples includes a log related to a bug and a correct category of a cause of the bug; conducting, for feature sequences prior to and subsequent to deletion of at least one feature element from the original feature sequence, classification prediction on the cause of the bug in each of the log samples through a classification algorithm; and determining a target feature sequence based on a maximum error ratio of each of the log samples prior to and subsequent to deletion of the at least one feature element. The maximum error ratio is a ratio between a maximum probability of the cause belonging to an incorrect category subsequent to the classification prediction and a probability of the cause belonging to a correct category subsequent to the classification prediction, and a quantity of feature elements in the target feature sequence is less than or equal to a quantity of feature elements in the original feature sequence.

In some embodiments, said determining the target feature sequence based on the maximum error ratio of each of the log samples includes: determining whether the maximum error ratio of each of the log samples decreases in response to a sum of the maximum error ratios of all the log samples decreases subsequent to deletion of the feature element; and determining the feature sequence subsequent to deletion of the feature element as the target feature sequence in response to the maximum error ratio of each log sample decreases.

In some embodiments, the method further includes: determining, in response to the maximum error ratio of any one of the log samples does not decrease, whether to conduct classification prediction to classify the cause of the bug into the correct category based on the maximum error ratio that does not decrease; and determining the feature sequence subsequent to deletion of the feature element as the target feature sequence in response to the maximum error ratio of each of the log samples decreases.

In some embodiments, conducting, for the feature sequences prior to and subsequent to deletion of at least one feature element from the original feature sequence, the classification prediction on the cause of the bug in each of the log samples through the classification algorithm; and determining the target feature sequence based on the maximum error ratio of each of the log samples prior to and subsequent to deletion of the at least one feature element includes: deleting the feature elements from the original feature sequence one by one; conducting, for feature sequences prior to and subsequent to deletion of the feature element, classification prediction on the cause of the bug in each of the log samples through the classification algorithm; determining whether a condition is satisfied based on the maximum error ratio of each of the log samples subsequent to deletion of the feature element; updating, in response to the condition satisfied, the original feature sequence with the feature sequence from which the feature element has been deleted; or restoring, in response to the condition not satisfied, the original feature sequence to the feature sequence prior to deletion of the feature element; and determining the original feature sequence as the target feature sequence.

According to a second aspect, the present disclosure provides a system for determining log feature sequence, including an original feature extraction module configured to extract an original feature sequence of a log sample set, the log sample set includes a plurality of log samples, and each of the log samples includes a log related to a bug and a correct category of a cause of the bug; a first classification prediction module configured to conduct, for feature sequences prior to and subsequent to deletion of at least one feature element from the original feature sequence, classification prediction on the cause of the bug in each of the log samples through a classification algorithm; and a target feature determining module configured to determine a target feature sequence based on a maximum error ratio of each of the log samples prior to and subsequent to deletion of the feature element; the maximum error ratio is a ratio between a maximum probability of the cause belonging to an incorrect category subsequent to the classification prediction and a probability of the cause belonging to a correct category subsequent to the classification prediction, and a quantity of feature elements in the target feature sequence is less than or equal to a quantity of feature elements in the original feature sequence.

In some embodiments, the target feature determining module includes a first judging unit and a first determining unit, the first judging unit is configured to determine whether the maximum error ratio of each of the log samples decreases in response to a sum of the maximum error ratios of all the log samples decreases subsequent to deletion of the feature element, and call the first determining unit; and the first determining unit is configured to determine the feature sequence subsequent to deletion of the feature element as the target feature sequence.

In some embodiments, the first judging unit is further configured to determine, in response to the maximum error ratio of any one of the log samples does not decrease, whether to conduct classification prediction to classify the cause of the bug into the correct category based on the maximum error ratio that does not decrease, and call the first determining unit in response to the maximum error ratio of each log sample decreases.

In some embodiments, the system further includes a feature element deletion module; and the target feature determining module includes a second judging unit and a second determining unit, the feature element deletion module is configured to delete the feature elements from the original feature sequence one by one, and sequentially call the first classification prediction module and the second judging unit; the first classification prediction module is configured to conduct, for feature sequences prior to and subsequent to deletion of the feature element, classification prediction on the cause of the bug in each of the log samples through the classification algorithm; the second judging unit is configured to determine whether a condition is satisfied based on the maximum error ratio of each of the log samples subsequent to deletion of the feature element; in response to the condition satisfied, update the original feature sequence with the feature sequence from which the feature element has been deleted; or in response to the condition not satisfied, restore the original feature sequence to the feature sequence prior to deletion of the feature element; and the second determining unit is configured to determine the original feature sequence as the target feature sequence.

According to a third aspect, the present disclosure provides a method for analyzing bug, including: obtaining logs related to a bug; extracting a target feature sequence of the logs, the target feature sequence is determined by the method for determining log feature sequence as described in the first aspect; and conducting, for the target feature sequence, classification prediction on causes of the bug through a classification algorithm

According to a fourth aspect, the present disclosure provides a system for analyzing bug, including: a bug log obtaining module configured to obtain logs related to a bug; a target feature extraction module configured to extract a target feature sequence of the logs, the target feature sequence is determined by the system for determining log feature sequence as described in the second aspect; and a second classification prediction module configured to conduct, for the target feature sequence, classification prediction on causes of the bug through a classification algorithm.

According to a fifth aspect, the present disclosure provides an electronic device, including a memory, a processor, and a computer program stored in the memory and operable on the processor, the processor, when executing the computer program, is configured to implement the method for determining a log feature sequence as described in the first aspect or the method for analyzing bug as described in the third aspect.

According to a sixth aspect, the present disclosure provides a non-transitory storage medium, storing a computer program, the computer program, when executed by a processor, is configured to implement the method for determining log feature sequence as described in the first aspect or the method for analyzing bug as described in the third aspect.

### BRIEF DESCRIPTION OF DRAWINGS

FIG. 1 is a flowchart of a method for determining log feature sequence according to one or more embodiments of the present disclosure;

FIG. 2 is a diagram showing change of Σᵢ₌₁^{m}MER(bi) during optimization of a feature sequence;

FIG. 3 is a schematic diagram showing a classification prediction result of 16 log samples by using an original feature sequence;

FIG. 4 is a schematic diagram showing a classification prediction result of 16 log samples by using a target feature sequence;

FIG. 5 is a structural block diagram of a system for determining log feature sequence according to one or more embodiments of the present disclosure;

FIG. 6 is a flowchart of a method for analyzing bug according to one or more embodiments of the present disclosure;

FIG. 7 is a structural block diagram of a system for analyzing bug according to one or more embodiments of the present disclosure; and

FIG. 8 is a structural block diagram of an electronic device according to one or more embodiments of the present disclosure.

### DESCRIPTION OF EMBODIMENTS

The present disclosure is further illustrated through the following embodiments, it is appreciated that the present disclosure is not limited to the scope of the embodiments.

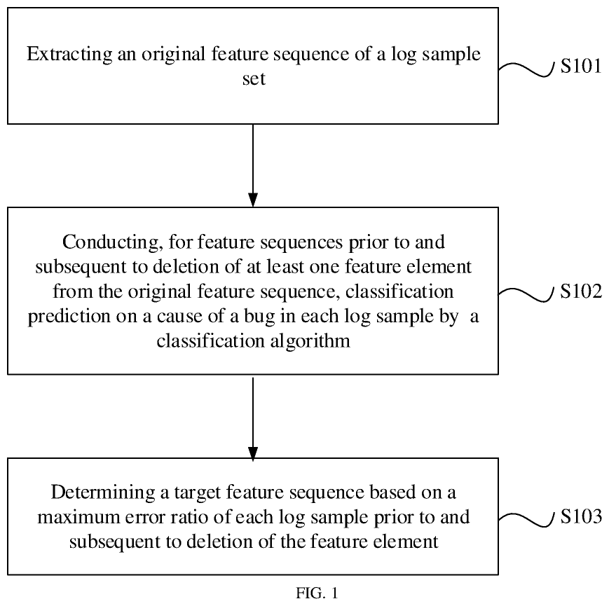

Embodiments of the present disclosure provide a method for determining log feature sequence. As shown in FIG. 1, the method includes the following steps.

At S101, an original feature sequence of a log sample set is extracted, the log sample set includes a plurality of log samples, and each log sample includes a log related to a bug and a correct category of a cause of the bug.

At S102, for feature sequences before and after deletion of at least one feature element from the original feature sequence, classification prediction is conducted on the cause of the bug in each log sample by using a classification algorithm.

It should be noted that, at S102, for the two different feature sequences, classification prediction is conducted on the cause of the bug in each log sample by using the classification algorithm. For the original feature sequence with the feature sequence before the at least one feature element deleted, classification prediction is conducted on the cause of the bug in each log sample by using the classification algorithm. For the original feature sequence with the feature sequence after the at least one feature element deleted, classification prediction is also conducted on the cause of the bug in each log sample by using the classification algorithm.

For example, the classification algorithm may be decision tree algorithm, Bayes classification algorithm, support vector machine (SVM) classification algorithm, artificial neural network (ANN) classification algorithm, k-nearest neighbor (KNN) classification algorithm, fuzzy classification algorithm, or the like.

At S103, a target feature sequence is determined according to a maximum error ratio of each log sample before and after deletion of the feature element.

The maximum error ratio is a ratio between a maximum probability of the cause belonging to an incorrect category after the classification prediction and a probability of the cause belonging to a correct category after the classification prediction. The maximum error ratio is recorded as MaxErrRatio. The quantity of feature elements in the target feature sequence is less than or equal to the quantity of feature elements in the original feature sequence.

In some embodiments, the original feature sequence is optimized by using the maximum error ratio of the log sample. The target feature sequence is determined by deleting the feature element having most contribution to the maximum error ratio, thereby improving the accuracy of the subsequent classification prediction of the cause of the bug in the log by using the target feature sequence.

To reduce the amount of computation and improve the efficiency and convenience of computation, in some embodiments, the logarithm of the maximum error ratio MaxErrRatio is obtained and denoted by MER; the target feature sequence is determined based on MER. In some examples, the base of the logarithm is e, i.e., ln(MaxErrRatio)=MER. In some other examples, the base of the logarithm is 10, i.e., lg(MaxErrRatio)=MER. In some other examples, the base of the logarithm can be other values, which are not specified herein.

The Bayesian classification algorithm is taken as an example below for description.

It is assumed that the log sample set B={1, b2 . . . , bm}, where bi is a log sample, and i=1, 2 . . . , m. The log sample set includes a total of m log samples. The log sample set B corresponds to a correct category set C={Cb1, Cb2 . . . , Cbm}. That is, the correct category of the cause of the bug in the log sample b1 is Cb1, the correct category of the cause of the bug in the log sample b2 is Cb2, and the correct category of the cause of the bug in the log sample bm is Cbm. An original feature sequence of the log sample set B is extracted: X={x(1), x(2) . . . , x(n)}, where x(j) is a feature element, and j=1, 2 . . . , n. Categories obtained by conducting classification prediction on causes in the log samples by using the classification algorithm are Y={C1, C2 . . . , Ck}, where C1 is a cause category, l=1, 2 . . . , k, and C belongs to Y.

The maximum error ratio MaxErrRatio(bi) of the log sample bi is calculated by using the following formula:

$$\begin{matrix}P ( X = x \vert Y = Cbi ) = P ( X ( 1 ) = \begin{matrix}x ( 1 ) , X ( 2 ) = x ( 2 ) , … , \\ X ( n ) = x ( n ) \vert Y = Cbi )\end{matrix} \\ = {\prod }_{j} P ( X ( j ) = x ( j ) \vert Y = Cbi )\end{matrix} \\ \begin{matrix}P ( Y = Cbi \vert X = x ) = \frac{P ( X = x \vert Y = Cbi ) P ( Y = Cbi )}{{\sum }_{l = 1}^{k} P ( X = x \vert Y = Cl ) P ( Y = Cl )} \\ = \frac{P ( Y = Cbi ) {\prod }_{j} P ( X ( j ) = x ( j ) \vert Y = Cbi )}{{\sum }_{l = 1}^{k} P ( Y = Cl ) {\prod }_{j} P ( X ( j ) = x ( j ) \vert Y = Cl )}\end{matrix} \\ \begin{matrix}P ( X = x \vert Y = C\_bi ) = P ( X ( 1 ) = \begin{matrix}x ( 1 ) , X ( 2 ) = x ( 2 ) , … , \\ X ( n ) = x ( n ) \vert Y = C\_bi )\end{matrix} \\ = {\prod }_{j} P ( X ( j ) = x ( j ) \vert Y = C\_bi )\end{matrix} \\ \begin{matrix}P ( Y = C\_bi \vert X = x ) = \frac{P ( X = x \vert Y = C\_bi ) P ( Y = C\_bi )}{{\sum }_{l = 1}^{k} P ( X = x \vert Y = Cl ) P ( Y = Cl )} \\ = \frac{P ( Y = C\_bi ) {\prod }_{j} P ( X ( j ) = x ( j ) \vert Y = C\_bi )}{{\sum }_{l = 1}^{k} P ( Y = Cl ) {\prod }_{j} P ( X ( j ) = x ( j ) \vert Y = Cl )}\end{matrix} \\ \begin{matrix}Max Err Ratio ( bi ) = Max \{ P ( Y = C\_bi \vert X = x ) \} / P ( Y = Cbi \vert X = x ) \\ = \frac{Max \{ P ( Y = C\_bi ) {\prod }_{j} P ( X ( j ) = x ( j ) \vert Y = C\_bi ) \}}{P ( Y = Cbi ) {\prod }_{j} P ( X ( j ) = x ( j ) \vert Y = Cbi ) \}}\end{matrix}$$

C_bi represents categories other than Cbi, i.e., all incorrect categories. Max{P(Y=C_bi|X=x)} is a maximum probability of the cause belonging to the categories other than Cbi, i.e., all the incorrect categories, and P(Y=Cbi|X=x) is a probability of the cause belonging to the category Cbi, that is, the correct category.

For MaxErrRatio(bi), MER(bi) is obtained after a logarithmic operation with the base of e:

$$MER ( bi ) = Max \{ ln ( P ( Y = C\_bi ) ) + {\sum }_{j = 1}^{n} ln ( P ( X ( j ) = x ( j ) \vert Y = Cbi ) ) \} - ln ( P ( Y = Cbi ) ) - {\sum }_{j = 1}^{n} ln ( P ( X ( j ) = x ( j ) \vert Y = Cbi ) )$$

It should be noted that, as can be obtained from the foregoing formulas and the definition of the maximum error ratio, if MaxErrRatio (bi)<1, it indicates that the category of the cause of the bug in the log sample bi obtained by classification prediction using the classification algorithm is correct; otherwise, if MaxErrRatio(bi)>1, it indicates that the category of the cause of the bug in the log sample bi obtained by classification prediction using the classification algorithm is incorrect. If MER(bi)<0, it indicates that the category of the cause of the bug in the log sample bi obtained by classification prediction using the classification algorithm is correct; otherwise, if MER(bi)>0, it indicates that the category of the cause of the bug in the log sample bi obtained by classification prediction using the classification algorithm is incorrect.

A feature sequence after at least one feature element is deleted from the original feature sequence X is X′={x′(1), x′(2) . . . , x′(n′)}, where x′(j′) is a feature element, j′=1, 2 . . . , n′, and n-n′≥1.

$$\begin{matrix}Max {ErrRatio}^{′} ( bi ) = {Max}^{′} \{ P ( Y = C\_bi \vert X = {x}^{′} ) \} / P ( Y = Cbi \vert X = {x}^{′} ) \\ = \frac{{Max}^{′} \{ P ( Y = C\_bi ) {\prod }_{{j}^{′}} P ( {X}^{′} ( {j}^{′} ) = {x}^{′} ( {j}^{′} ) \vert Y = C\_bi ) \}}{P ( Y = Cbi ) {\prod }_{{j}^{′}} P ( {X}^{′} ( {j}^{′} ) = {x}^{′} ( {j}^{′} ) \vert Y = Cbi ) \}}\end{matrix}$$

For MaxErrRatio′(bi), MER′(bi) is obtained after a logarithmic operation with the base of e:

$${MER}^{′} ( bi ) = {Max}^{′} \{ ln ( P ( Y = C\_bi ) ) + {\sum }_{{j}^{′} = 1}^{{n}^{′}} ln ( P ( {X}^{′} ( {j}^{′} ) = x ( {j}^{′} ) \vert Y = Cbi ) ) \} - ln ( P ( Y = Cbi ) ) - {\sum }_{{j}^{′} = 1}^{{n}^{′}} ln ( P ( {X}^{′} ( {j}^{′} ) = {x}^{′} ( {j}^{′} ) \vert Y = Cbi ) )$$

In an optional implementation of S103, in a case that a sum of the maximum error ratios of all the log samples decreases after deletion of the feature element, it is determined whether the maximum error ratio of each log sample decreases. The feature sequence after deletion of the feature element is determined as the target feature sequence in a case that the maximum error ratio of each log sample decreases.

In the foregoing example, for the original feature sequence X, a sum of the maximum error ratios of all the log samples in the log sample set B is calculated: Σᵢ₌₁^{m}MaxErrRatio(bi). For the feature sequence X′, a sum of the maximum error ratios of all the log samples in the log sample set B is calculated: Σᵢ₌₁^{m}MaxErrRatio′(bi). If the sum of the maximum error ratios Σᵢ₌₁^{m}MaxErrRatio′(bi) of all the log samples decreases after deletion of the feature element, i.e., Σᵢ₌₁^{m}MaxErrRatio(bi)−Σᵢ₌₁^{m}MaxErrRatio′(bi) >β, and the maximum error ratio of each log sample decreases, i.e., MaxErrRatio′(bi)−MaxErrRatio′(bi)>α, where i=1, 2 . . . , m, the feature sequence X′ after deletion of the feature element is determined as the target feature sequence. Otherwise, the feature sequence before deletion of the feature element, that is, the original feature sequence X, is determined as the target feature sequence. α and β are both preset values greater than or equal to 0.

For MaxErrRatio(bi), MER(bi) is obtained after a logarithmic operation with the base of e; for MaxErrRatio′(bi), MER′(bi) is obtained after a logarithmic operation with the base of e. In another example, if Σᵢ₌₁^{m}MER(bi)−Σᵢ₌₁^{m}MER′(bi)>β′, and MER(bi)−MER′(bi)>α′, where i=1, 2 . . . , m, the feature sequence X′ after deletion of the feature element is determined as the target feature sequence. Otherwise, the feature sequence before deletion of the feature element, that is, the original feature sequence X, is determined as the target feature sequence. α′ and β′ are both preset values greater than or equal to 0.

In some embodiment, at S103, the method further includes the following steps:

In a case that the maximum error ratio of any one of the log samples does not decrease, it is determined whether to conduct classification prediction to classify the cause of the bug into the correct category according to the maximum error ratio that does not decrease. In an example, there is only one log sample whose maximum error ratio does not decrease, it is only necessary to determine whether to conduct classification prediction to classify the cause of the bug into the correct category according to the maximum error ratio that does not decrease. In other examples, there are a plurality of log samples whose maximum error ratios do not decrease, it is necessary to determine whether to conduct classification prediction to classify the cause of the bug into the correct category according to each maximum error ratio that does not decrease.

The feature sequence after deletion of the feature element is determined as the target feature sequence in a case that the maximum error ratio of each log sample decreases.

In foregoing example, if Σᵢ₌₁^{m}MaxErrRatio(bi)−Σᵢ₌₁^{m}MaxErrRatio′(bi) >β, and the maximum error ratio of any one of the log samples does not decrease, i.e., MaxErrRatio(bi)−MaxErrRatio′^{(bi)}<α, it is determined whether to conduct classification prediction to classify the cause of the bug into the correct category according to the maximum error ratio MaxErrRatio′(bi) that does not decrease, that is, determining whether MaxErrRatio′(bi) is less than 1. If MaxErrRatio′(bi)<1, the feature sequence X′ after deletion of the feature element is determined as the target feature sequence; if MaxErrRatio′(bi)>1, the feature sequence before deletion of the feature element, that is, the original feature sequence X, is determined as the target feature sequence.

In another example, if Σᵢ₌₁^{m}MER(bi)−Σᵢ₌₁^{m}MER′(bi)>β′ and MER(bi)−MER′(bi)<α′, it is determined according to MER′(bi) whether to conduct classification prediction to classify the cause of the bug into the correct category, i.e., determining whether MER′(bi) is less than p. If MER′(bi)<p, the feature sequence X′ after deletion of the feature element is determined as the target feature sequence. If MER′(bi)>p, the feature sequence before deletion of the feature element, that is, the original feature sequence X, is determined as the target feature sequence. p is a preset value less than or equal to 0. In an example, p is −10, and the probability that the cause of the bug in the log sample bi obtained by classification prediction belongs to the correct category is 22000 times greater than the probability that the cause belongs to the incorrect category.

In some embodiments, S102 and S103 include the following steps.

At S201, the feature elements are deleted from the original feature sequence one by one.

At S202, for feature sequences before and after deletion of the feature element, classification prediction is conducted on the cause of the bug in each log sample by using the classification algorithm.

At S203, it is determined whether a condition is satisfied according to the maximum error ratio of each log sample after deletion of the feature element. In a case that the condition is satisfied, the original feature sequence is updated with the feature sequence from which the feature element has been deleted. Otherwise, the original feature sequence is restored to the feature sequence before deletion of the feature element.

At S204: the original feature sequence is determined as the target feature sequence.

It should be noted that, after S203 is conducted, the process returns to S201, until the last feature element in the original feature sequence is deleted, and then S204 is conducted after S203. If the maximum error ratio of each log sample satisfies the condition after deletion of the feature element, the feature element will be actually deleted from the original feature sequence, which means the original feature sequence is updated with the feature sequence from which the feature element has been deleted. If the maximum error ratio of each log sample does not satisfy the condition after deletion of the feature element, the feature element is not actually deleted from the original feature sequence, which means the original feature sequence is restored to the feature sequence before deletion of the feature element.

In some embodiments, if a sum of the maximum error ratios of all the log samples decreases after deletion of the feature element, and the maximum error ratio of each log sample decreases, the condition at S203 is satisfied.

In other embodiments, the condition at S203 is satisfied if a sum of the maximum error ratios of all the log samples decreases after deletion of the feature element, but not every log sample has a decreased maximum error ratio, and it is determined to conduct classification prediction to classify the cause of the bug into the correct category according to the maximum error ratio that does not decrease. In some examples, there is only one log sample whose maximum error ratio does not decrease, the condition is satisfied when conducting classification prediction to classify the cause of the bug into the correct category according to the maximum error ratio that does not decrease. In other examples, there are a plurality of log samples whose maximum error ratios do not decrease, the condition is satisfied when conducting classification prediction to classify the cause of the bug into the correct category according to each maximum error ratio that does not decrease.

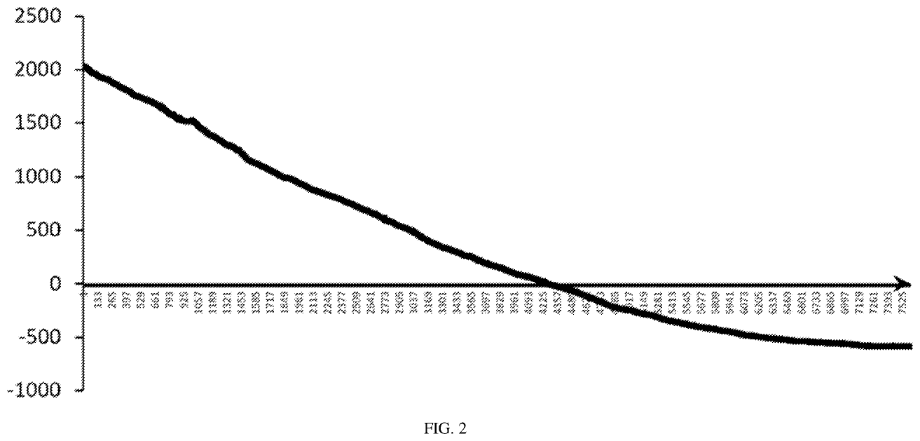

FIG. 2 is a diagram showing change of Σᵢ₌₁^{m}MER(bi) during optimization of a feature sequence. In FIG. 2, the x-axis is the position of the feature element in the original feature sequence, and the y-axis is the value of Σᵢ₌₁^{m}MER(bi). As shown in FIG. 2, as more feature elements in the original feature sequence are traversed, the value of Σᵢ₌₁^{m}MER(bi) gradually decreases, that is, the result of the classification prediction is more accurate.

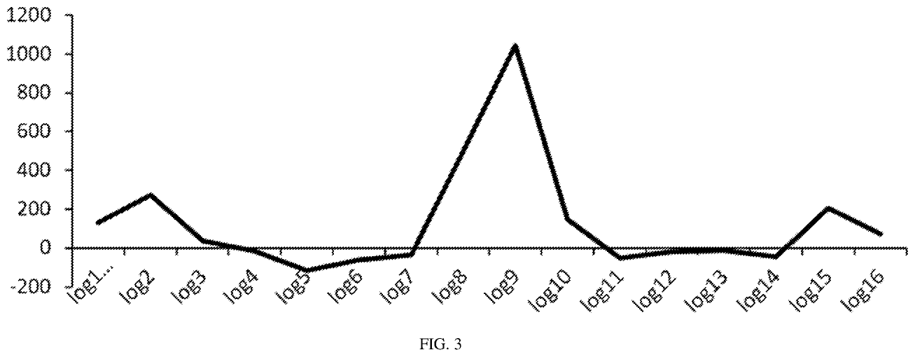

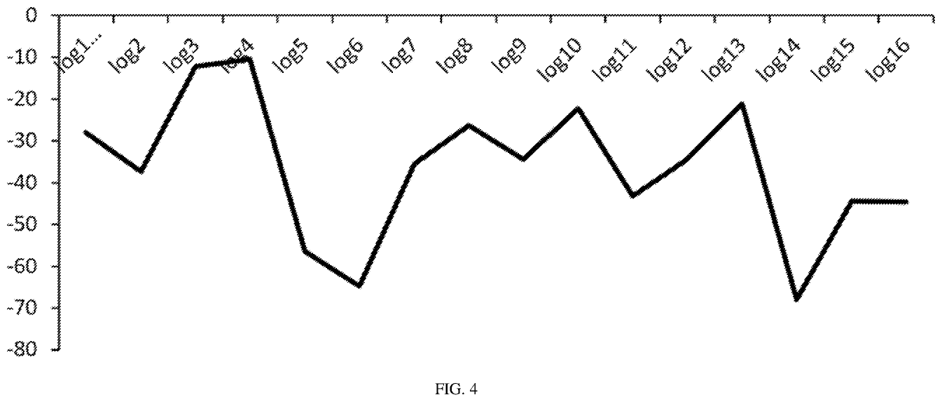

FIG. 3 is a schematic diagram showing a classification prediction result of 16 log samples by using an original feature sequence. The x-axis is the serial number of the log sample, and the y-axis is the value of Σᵢ₌₁^{m}MER(bi). FIG. 4 is a schematic diagram showing a classification prediction result of 16 log samples by using a target feature sequence. The x-axis is the serial number of the log sample, and the y-axis is the value of Σᵢ₌₁^{m}MER(bi). As shown in FIG. 3, the results of the classification prediction for the log samples log 4 to log 7 and log 11 to log 14 are correct, and the results of the classification prediction for other log samples are incorrect. The accuracy rate is only 50%. As shown in FIG. 4, the results of the classification prediction for the log samples log 1 to log 16 are all correct, and the accuracy rate reaches 100%.

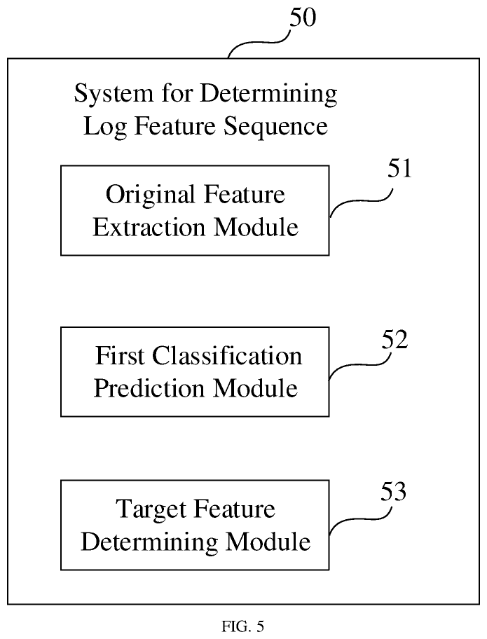

Some embodiments of the present disclosure provide a system 50 for determining log feature sequence. As shown in FIG. 5, the system includes an original feature extraction module 51, a first classification prediction module 52, and a target feature determining module 53.

The original feature extraction module 51 is configured to extract an original feature sequence of a log sample set. The log sample set includes a plurality of log samples, and each log sample includes a log related to a bug and a correct category of a cause of the bug.

The first classification prediction module 52 is configured to conduct, for feature sequences before and after deletion of at least one feature element from the original feature sequence, classification prediction on the cause of the bug in each log sample by using a classification algorithm.

The target feature determining module 53 is configured to determine a target feature sequence according to a maximum error ratio of each log sample before and after deletion of the feature element.

The maximum error ratio is a ratio between a maximum probability of the cause belonging to an incorrect category after the classification prediction and a probability of the cause belonging to a correct category after the classification prediction. The quantity of feature elements in the target feature sequence is less than or equal to the quantity of feature elements in the original feature sequence.

In some embodiments, the target feature determining module includes a first judging unit and a first determining unit.

The first judging unit is configured to determine whether the maximum error ratio of each log sample decreases in a case that a sum of the maximum error ratios of all the log samples decreases after deletion of the feature element, and if yes, call the first determining unit.

The first determining unit is configured to determine the feature sequence after deletion of the feature element as the target feature sequence.

In some embodiments, the first judging unit is further configured to determine, in a case that the maximum error ratio of any one of the log samples does not decrease, whether to conduct classification prediction to classify the cause of the bug into the correct category according to the maximum error ratio that does not decrease, and call the first determining unit in a case that the maximum error ratio of each log sample decreases.

In some embodiments, the system further includes a feature element deletion module; and the target feature determining module includes a second judging unit and a second determining unit.

The feature element deletion module is configured to delete the feature elements from the original feature sequence one by one, and sequentially call the first classification prediction module and the second judging unit.

The first classification prediction module is configured to conduct, for feature sequences before and after deletion of the feature element, classification prediction on the cause of the bug in each log sample by using the classification algorithm.

The second judging unit is configured to determine whether a condition is satisfied according to the maximum error ratio of each log sample after deletion of the feature element; in a case that the condition is satisfied, update the original feature sequence with the feature sequence from which the feature element has been deleted; otherwise, restore the original feature sequence to the feature sequence before deletion of the feature element.

The second determining unit is configured to determine the original feature sequence as the target feature sequence.

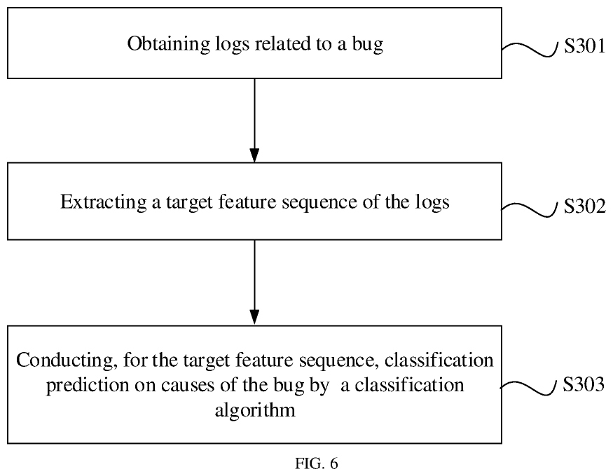

Some embodiments of the present disclosure provide a method for analyzing bug. As shown in FIG. 6, the method includes the following steps.

At S301, logs related to a bug are obtained.

At S302, a target feature sequence of the logs is extracted. The target feature sequence is determined by using the method for determining log feature sequence according to one or more embodiments.

At S303, for the target feature sequence, classification prediction is conducted on causes of the bug by using a classification algorithm.

The classification prediction is conducted on the cause of the bug in the log by using the target feature sequence, thereby improving the accuracy of the classification prediction.

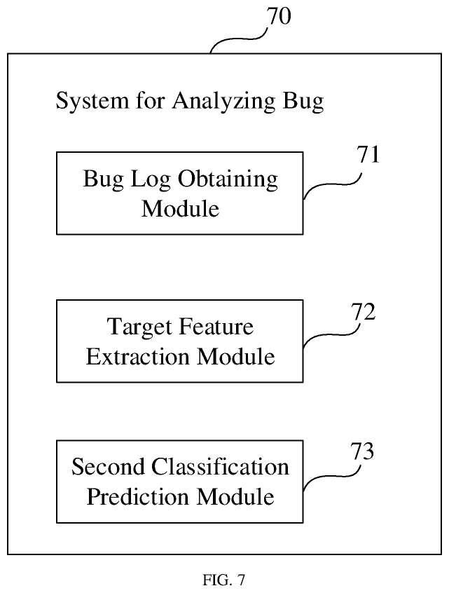

Some embodiments of the present disclosure provide a system 70 for analyzing bug. As shown in FIG. 7, the system includes a bug log obtaining module 71, a target feature extraction module 72, and a second classification prediction module 73.

The bug log obtaining module 71 is configured to obtain logs related to a bug.

The target feature extraction module 72 is configured to extract a target feature sequence of the logs. The target feature sequence is determined by using the system for determining log feature sequence according to the above embodiments.

The second classification prediction module 73 is configured to conduct, for the target feature sequence, classification prediction on causes of the bug by using a classification algorithm.

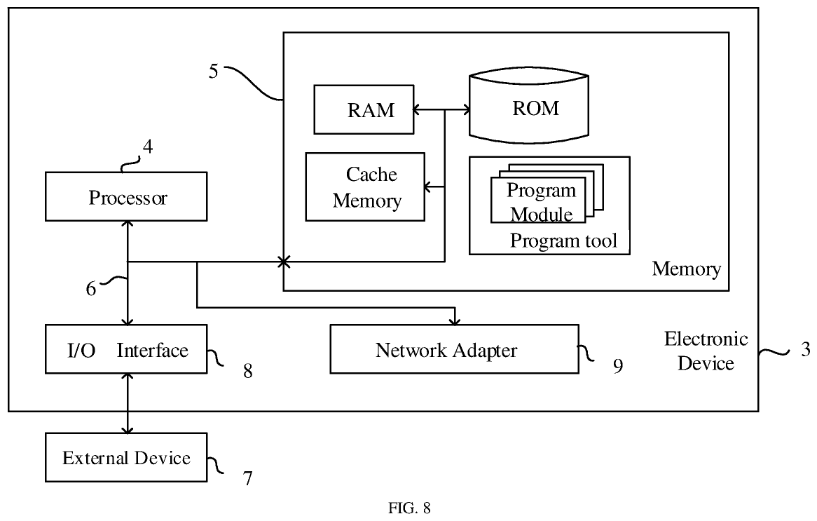

FIG. 8 is a schematic structural diagram of an electronic device according to one or more embodiments of the present disclosure. The electronic device includes at least one memory, at least one processor, a computer program stored in the memory and operable on the processor, and a plurality of sub-systems for implementing different functions. The processor is configured to implement the method for determining log feature sequence in one or more embodiments as above and a method for analyzing bug in one or more embodiments as above when executing the program. The electronic device 3 shown in FIG. 8 is merely an example, and should not cause any limitation to the functions and application range of the embodiments of the present disclosure.

Components of the electronic device 3 may include, but are not limited to: at least one processor 4 described above, at least one memory 5 described above, and a bus 6 connecting different system components (including the memory 5 and the processor 4).

The bus 6 includes a data bus, an address bus, and a control bus.

The memory 5 may include a non-transitory memory, such as a random access memory (RAM) and/or a cache memory, and may further include a read-only memory (ROM).

The memory 5 may further include a program/utility including a set of (at least one) program modules, and the program module includes, but is not limited to: an operating system, one or more applications, other program modules and program data. Each of these examples or some combinations thereof may include an implementation of a network.

By running the computer program stored in the memory 5, the processor 4 conducts various functional applications and data processing, thereby implementing the method for determining log feature sequence in one or more embodiments described as above or the method for analyzing bug in one or more embodiments described as above.

The electronic device 3 may further communicate with one or more external devices 7 (for example, a keyboard or a pointing device). Such communication may be conducted via an input/output (I/O) interface 8. Moreover, the electronic device 3 may also communicate with one or more networks (e.g., a local area network (LAN), a wide area network (WAN), and/or a public network, such as the Internet) through a network adapter 9. As shown in FIG. 8, the network adapter 9 communicates with other modules of the electronic device 3 via the bus 6. It should be appreciated that although not shown in FIG. 8, other hardware and/or software modules may be used in conjunction with the electronic device 3, including but not limited to: microcode, device drives, redundant processors, external disk drive arrays, redundant arrays of independent disks (RAID) systems, tape drives, and data backup storage systems.

It should be noted that although various units/modules or sub-units/sub-modules of the electronic device are mentioned in the detailed description above, such division is merely an example but are not mandatory. In fact, according to the embodiments of the present disclosure, the features and functions of two or more units/modules described above may be implemented in a single unit/module. Conversely, the features and functions of one unit/module described above may be further divided into a plurality of units/modules to be embodied.

Some embodiments of the present disclosure provide a computer readable storage medium, storing a computer program. The computer program, when executed by a processor, implements steps of the method for determining log feature sequence in one or more embodiments as described above or steps of the method for analyzing bug in one or more embodiments as described above. More specific examples of the readable storage medium may include, but are not limited to: a portable disk, a hard drive, a RAM, a ROM, an erasable programmable ROM, an optical storage device, a magnetic storage device, or any proper combination of the above.

In some embodiments, the present disclosure may also be implemented in the form of a program product including program code. When the program product is run on a terminal device, the program code is used to cause the terminal device to conduct the steps of the method for determining log feature sequence in one or more embodiments as described above or the steps of the method for analyzing bug in one or more embodiments as described above.

Program code for executing the present disclosure may be compiled by using one or more programming languages or any combination thereof. The program code can be executed fully on user equipment, executed partially on user equipment, executed as an independent software package, executed partially on user equipment and partially on a remote device, or fully executed on a remote device.

The method, system, electronic device and medium disclosed in the above embodiments may achieve the following technical effect: the original feature sequence is optimized by using the maximum error ratio of the log sample; the target feature sequence is determined by deleting the feature element that contributes the most to the maximum error ratio, thereby improving the accuracy of the subsequent classification prediction conducted on the cause of the bug in the log by using the target feature sequence.

Although the implementations of the present disclosure are described above, person skilled in the art should understand that such implementations are merely examples for description, and the protection scope of the present disclosure is determined by the appended claims. Changes or modifications may be made on these implementations by a person skilled in the art without departing from the principle and essence of the present disclosure, and all such changes and modifications fall within the protection scope of the present disclosure.

1. A method for determining log feature sequence, comprising:
extracting an original feature sequence of a log sample set, wherein the log sample set comprises a plurality of log samples, and each of the log samples comprises a log related to a bug and a correct category of a cause of the bug;
conducting, for feature sequences prior to and subsequent to deletion of at least one feature element from the original feature sequence, classification prediction on the cause of the bug in each of the log samples through a classification algorithm; and
determining a target feature sequence based on a maximum error ratio of each of the log samples prior to and subsequent to deletion of the at least one feature element;
wherein the maximum error ratio is a ratio between a maximum probability of the cause belonging to an incorrect category subsequent to the classification prediction and a probability of the cause belonging to a correct category subsequent to the classification prediction, and a quantity of feature elements in the target feature sequence is less than or equal to a quantity of feature elements in the original feature sequence.

2. The method according to claim 1, wherein said determining the target feature sequence based on the maximum error ratio of each of the log samples comprises:
determining whether the maximum error ratio of each of the log samples decreases in response to a sum of the maximum error ratios of all the log samples decreases subsequent to deletion of the feature element; and
determining the feature sequence subsequent to deletion of the feature element as the target feature sequence in response to the maximum error ratio of each log sample decreases.

3. The method according to claim 2, further comprising:
determining, in response to the maximum error ratio of any one of the log samples does not decrease, whether to conduct classification prediction to classify the cause of the bug into the correct category based on the maximum error ratio that does not decrease; and
determining the feature sequence subsequent to deletion of the feature element as the target feature sequence in response to the maximum error ratio of each of the log samples decreases.

4. The method according to claim 1, wherein said conducting, for the feature sequences prior to and subsequent to deletion of at least one feature element from the original feature sequence, the classification prediction on the cause of the bug in each of the log samples through the classification algorithm; and determining the target feature sequence based on the maximum error ratio of each of the log samples prior to and subsequent to deletion of the at least one feature element comprises:
deleting the feature elements from the original feature sequence one by one;
conducting, for feature sequences prior to and subsequent to deletion of the feature element, classification prediction on the cause of the bug in each of the log samples through the classification algorithm;
determining whether a condition is satisfied based on the maximum error ratio of each of the log samples subsequent to deletion of the feature element;
updating, in response to the condition satisfied, the original feature sequence with the feature sequence from which the feature element has been deleted; or restoring, in response to the condition not satisfied, the original feature sequence to the feature sequence prior to deletion of the feature element; and
determining the original feature sequence as the target feature sequence.

5. A system for determining log feature sequence, comprising:
at least one processor; and
a memory configured to store instructions executable by the at least one processor:
wherein the instructions cause the at least one processor to:
extract an original feature sequence of a log sample set, wherein the log sample set comprises a plurality of log samples, and each of the log samples comprises a log related to a bug and a correct category of a cause of the bug;
conduct, for feature sequences prior to and subsequent to deletion of at least one feature element from the original feature sequence, classification prediction on the cause of the bug in each of the log samples through a classification algorithm; and
determine a target feature sequence based on a maximum error ratio of each of the log samples prior to and subsequent to deletion of the feature element;
wherein the maximum error ratio is a ratio between a maximum probability of the cause belonging to an incorrect category subsequent to the classification prediction and a probability of the cause belonging to a correct category subsequent to the classification prediction, and a quantity of feature elements in the target feature sequence is less than or equal to a quantity of feature elements in the original feature sequence.

6. The system according to claim 5, wherein the at least one processor is further configured to:
determine whether the maximum error ratio of each of the log samples decreases in response to a sum of the maximum error ratios of all the log samples decreases subsequent to deletion of the feature element; and
determine the feature sequence subsequent to deletion of the feature element as the target feature sequence.

7. The system according to claim 6, wherein the at least one processor is further configured to determine, in response to the maximum error ratio of any one of the log samples does not decrease, whether to conduct classification prediction to classify the cause of the bug into the correct category based on the maximum error ratio that does not decrease.

8. The system according to claim 5, wherein the at least one processor is further configured to:
delete the feature elements from the original feature sequence one by one;
conduct, for feature sequences prior to and subsequent to deletion of the feature element, classification prediction on the cause of the bug in each of the log samples through the classification algorithm;
determine whether a condition is satisfied based on the maximum error ratio of each of the log samples subsequent to deletion of the feature element; in response to the condition satisfied, update the original feature sequence with the feature sequence from which the feature element has been deleted; or in response to the condition not satisfied, restore the original feature sequence to the feature sequence prior to deletion of the feature element; and
determine the original feature sequence as the target feature sequence.

9. (canceled)

10. (canceled)

11. (canceled)

12. A non-transitory storage medium, storing a computer program instructions thereon, wherein the computer program instructions, when executed by at least one processor, cause the at least one processor to:
extract an original feature sequence of a log sample set, wherein the log sample set comprises a plurality of log samples, and each of the log samples comprises a log related to a bug and a correct category of a cause of the bug;
conduct for feature sequences prior to and subsequent to deletion of at least one feature element from the original feature sequence, classification prediction on the cause of the bug in each of the log samples through a classification algorithm; and
determine a target feature sequence based on a maximum error ratio of each of the log samples prior to and subsequent to deletion of the feature element;
wherein the maximum error ratio is a ratio between a maximum probability of the cause belonging to an incorrect category subsequent to the classification prediction and a probability of the cause belonging to a correct category subsequent to the classification prediction, and a quantity of feature elements in the target feature sequence is less than or equal to a quantity of feature elements in the original feature sequence.

13. The method according to claim 2, wherein said conducting, for the feature sequences prior to and subsequent to deletion of at least one feature element from the original feature sequence, the classification prediction on the cause of the bug in each of the log samples through the classification algorithm; and determining the target feature sequence based on the maximum error ratio of each of the log samples prior to and subsequent to deletion of the at least one feature element comprises:
deleting the feature elements from the original feature sequence one by one;
conducting, for feature sequences prior to and subsequent to deletion of the feature element, classification prediction on the cause of the bug in each of the log samples through the classification algorithm;
determining whether a condition is satisfied based on the maximum error ratio of each of the log samples subsequent to deletion of the feature element;
updating, in response to the condition satisfied, the original feature sequence with the feature sequence from which the feature element has been deleted; or restoring, in response to the condition not satisfied, the original feature sequence to the feature sequence prior to deletion of the feature element; and
determining the original feature sequence as the target feature sequence.

14. The method according to claim 3, wherein said conducting, for the feature sequences prior to and subsequent to deletion of at least one feature element from the original feature sequence, the classification prediction on the cause of the bug in each of the log samples through the classification algorithm; and determining the target feature sequence based on the maximum error ratio of each of the log samples prior to and subsequent to deletion of the at least one feature element comprises:
deleting the feature elements from the original feature sequence one by one;
conducting, for feature sequences prior to and subsequent to deletion of the feature element, classification prediction on the cause of the bug in each of the log samples through the classification algorithm;
determining whether a condition is satisfied based on the maximum error ratio of each of the log samples subsequent to deletion of the feature element;
updating, in response to the condition satisfied, the original feature sequence with the feature sequence from which the feature element has been deleted; or restoring, in response to the condition not satisfied, the original feature sequence to the feature sequence prior to deletion of the feature element; and
determining the original feature sequence as the target feature sequence.

15. The system according to claim 6, wherein the at least one processor is further configured to:
delete the feature elements from the original feature sequence one by one;
conduct, for feature sequences prior to and subsequent to deletion of the feature element, classification prediction on the cause of the bug in each of the log samples through the classification algorithm;
determine whether a condition is satisfied based on the maximum error ratio of each of the log samples subsequent to deletion of the feature element; in response to the condition satisfied, update the original feature sequence with the feature sequence from which the feature element has been deleted; or in response to the condition not satisfied, restore the original feature sequence to the feature sequence prior to deletion of the feature element; and
determine the original feature sequence as the target feature sequence.

16. The system according to claim 7, wherein the at least one processor is further configured to:
delete the feature elements from the original feature sequence one by one;
conduct, for feature sequences prior to and subsequent to deletion of the feature element, classification prediction on the cause of the bug in each of the log samples through the classification algorithm;
determine whether a condition is satisfied based on the maximum error ratio of each of the log samples subsequent to deletion of the feature element; in response to the condition satisfied, update the original feature sequence with the feature sequence from which the feature element has been deleted; or in response to the condition not satisfied, restore the original feature sequence to the feature sequence prior to deletion of the feature element; and
determine the original feature sequence as the target feature sequence.

17. The non-transitory storage medium according to claim 12, wherein the instructions further cause the at least one processor to:
determine whether the maximum error ratio of each of the log samples decreases in response to a sum of the maximum error ratios of all the log samples decreases subsequent to deletion of the feature element; and
determine the feature sequence subsequent to deletion of the feature element as the target feature sequence.

18. The non-transitory storage medium according to claim 17, wherein the instructions further cause the at least one processor to determine, in response to the maximum error ratio of any one of the log samples does not decrease, whether to conduct classification prediction to classify the cause of the bug into the correct category based on the maximum error ratio that does not decrease.

19. The non-transitory storage medium according to claim 12, wherein the instructions further cause the at least one processor to:
delete the feature elements from the original feature sequence one by one;
conduct, for feature sequences prior to and subsequent to deletion of the feature element, classification prediction on the cause of the bug in each of the log samples through the classification algorithm;
determine whether a condition is satisfied based on the maximum error ratio of each of the log samples subsequent to deletion of the feature element; in response to the condition satisfied, update the original feature sequence with the feature sequence from which the feature element has been deleted; or in response to the condition not satisfied, restore the original feature sequence to the feature sequence prior to deletion of the feature element; and
determine the original feature sequence as the target feature sequence.

20. The non-transitory storage medium according to claim 17, wherein the instructions further cause the at least one processor to:
delete the feature elements from the original feature sequence one by one;
conduct, for feature sequences prior to and subsequent to deletion of the feature element, classification prediction on the cause of the bug in each of the log samples through the classification algorithm;
determine whether a condition is satisfied based on the maximum error ratio of each of the log samples subsequent to deletion of the feature element; in response to the condition satisfied, update the original feature sequence with the feature sequence from which the feature element has been deleted; or in response to the condition not satisfied, restore the original feature sequence to the feature sequence prior to deletion of the feature element; and
determine the original feature sequence as the target feature sequence.

21. The non-transitory storage medium according to claim 18, wherein the instructions further cause the at least one processor to:
delete the feature elements from the original feature sequence one by one;
conduct, for feature sequences prior to and subsequent to deletion of the feature element, classification prediction on the cause of the bug in each of the log samples through the classification algorithm;
determine whether a condition is satisfied based on the maximum error ratio of each of the log samples subsequent to deletion of the feature element; in response to the condition satisfied, update the original feature sequence with the feature sequence from which the feature element has been deleted; or in response to the condition not satisfied, restore the original feature sequence to the feature sequence prior to deletion of the feature element; and
determine the original feature sequence as the target feature sequence.
